(19) United States
(12) Patent Application Publication
(10) Pub. No.: US 2014/0061249 A1
(43) Pub. Date: Mar. 6, 2014

(54) Chemical Applicator for Farming Applications

(71) Applicant: Unverferth Manufacturing Company, Inc., Kalida, OH (US)

(72) Inventors: Michael J. Hilvers, Fort Jennings, OH (US); David R. Smith, Fort Jennings, OH (US); John Garberson, Columbus Grove, OH (US)

(73) Assignee: Unverferth Manufacturing Company, Inc., Kalida, OH (US)

(21) Appl. No.: 14/011,547

(22) Filed: Aug. 27, 2013

Related U.S. Application Data
(60) Provisional application No. 61/693,747, filed on Aug. 27, 2012.

(51) Int. Cl. G01F 11/20

(52) U.S. Cl. CPC A01C 1/06
USPC 222/236

(57) ABSTRACT

A chemical applicator for use in a farm implement including a hopper, an auger, at least one agitator disc mounted to the hopper and a proportional rate device. The chemical applicator is configured to store material in the hopper and discharge the material from the auger on to seed or grain discharged from the farm implement. The at least one agitator disc is positioned such that it is driven by the auger. Therefore, the agitator disc does not need a separate motor to drive it. The proportional rate device controls the rate of the auger relative to the rate at which seed or grain is discharged from the farm implement.

### CROSS-REFERENCE TO RELATED APPLICATIONS

The present application claims priority to U.S. Provisional Application No. 61/693,747, filed Aug. 27, 2012, the entire disclosure of which is incorporated herein by reference.

### BACKGROUND OF THE INVENTION

1. Field of the Invention

The present invention relates generally to a chemical applicator for farming applications, and, more specifically, to a chemical applicator including a worm drive agitator which is driven by a material conveying device of a farm implement to which the chemical applicator is coupled, thereby eliminating the need for an extra power train. The chemical applicator may also include a proportional drive rate mechanism that causes the application rate of the chemical to be proportional to the speed of a material conveying device to which the chemical applicator is coupled.

2. Description of the Related Art

In farming applications, chemical applicators are sometimes used to apply chemicals to material being conveyed, such as seed conveyed from a seed tender or grain or seed being conveyed from a grain cart. For example, in the case of a seed tender, powdery lubricant like talc or graphite are applied to the seed in order to lubricate the seed planting metering mechanism. Known chemical applicators apply chemicals to the material being conveyed at a constant rate. Therefore, even if the conveying device increases or decreases the speed at which the grain or seed is being conveyed, the rate at which the chemicals are applied does not change.

Such chemical applicators generally include a storage hopper in which the chemicals are stored. Most chemicals used in chemical applicators are powdery and not free flowing, i.e., the chemicals have a bit of adhesive quality, which can cause the material to pack. When the material packs, the material cannot be conveyed by the auger and the chemical applicator cannot function.

To prevent the material from packing, chemical applicators can include an agitator. A typical agitator includes an auger conveyor driven by a first shaft. The agitator can be driven by a secondary shaft. Multiple shafts require multiple bearings, seals, chains, belts and/or motors. The additional components present additional places for potential failure and require additional maintenance.

Embodiments of the present invention overcome the deficiencies of the prior art.

### BRIEF DESCRIPTION OF THE DRAWINGS

FIG. 1 illustrates a perspective view of a chemical applicator according to an embodiment of the present invention.

FIG. 2 illustrates a cutaway view of a chemical applicator according to an embodiment of the present invention.

FIG. 3 illustrates a top view of a chemical applicator according to an embodiment of the present invention.

FIG. 4 illustrates a top view of a chemical applicator according to an embodiment of the present invention.

FIG. 5 illustrates a perspective view of a chemical applicator with a proportional rate control mounted on a seed tender according to an embodiment of the present invention.

FIG. 6 illustrates a perspective view of a chemical applicator with a proportional rate control mounted on a seed tender according to an embodiment of the present invention.

FIGS. 7(a)-(c) illustrate an agitator disc for a chemical applicator according to an embodiment of the present invention.

FIGS. 8(a)-(d) illustrate an auger or flight for a chemical applicator according to an embodiment of the present invention.

### DETAILED DESCRIPTION OF THE PRESENT INVENTION

While the present invention may be embodied in many different forms, a number of illustrative embodiments are described herein with the understanding that the present disclosure is to be considered as providing examples and not intended to limit the invention to the preferred embodiments described and/or illustrated herein.

In an embodiment of the present invention, the chemical applicator includes a hopper and a novel worm drive agitator that can be implemented as a toothed disc or gear rotatably coupled to a wall of the hopper. The agitator is positioned such that it is driven by the conveying auger of the applicator and, therefore, does not require an additional shaft to be driven. In an embodiment, a proportional rate device couples the conveying device of a farm implement, such as a seed tender or a grain cart, with the conveyor auger of the chemical applicator.

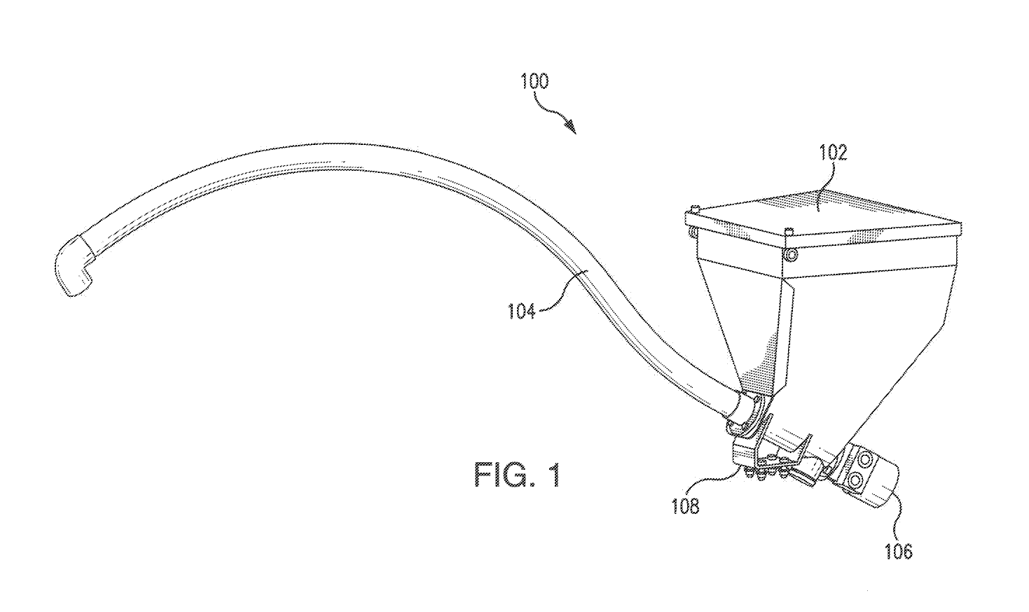

FIG. 1 illustrates a chemical applicator 100 according to an embodiment of the present invention. The chemical applicator 100 includes a hopper 102 and a discharge spout 104. The hopper 102 is configured to store chemicals used in farming applications. According to an embodiment of the present invention, the hopper 102 stores chemicals such as talc or graphite, which are lubricants that assist in the conveying of material from farm implements, such as seed tenders and grain carts, and help prevent jamming in the conveyors of such implements. The chemical applicator 100 can also be used to apply other chemicals, such as insecticides or fertilizers, that can be stored in the hopper 102. The hopper 102 primarily stores solid, granular material. The discharge spout 104 is coupled to an opening at a bottom of the hopper 102 and is configured to convey material discharged from the hopper 102. The rate at which the discharge spout 104 conveys material can be adjusted with the drive motor 106. Drive motor 106 can be an electric motor, a pneumatic motor, a hydraulic motor or any other type of motor suitable for driving a discharge auger and one or more agitators according to the present invention. In an embodiment of the present invention, the drive motor 106 includes a knob which can be rotatably adjusted to manually adjust the rate at which material is discharged from the hopper 102. The discharge spout 104 can include an auger conveyor, as discussed in further detail below, and the drive motor 106 can adjust the rate at which the auger conveyor is driven. The chemical applicator 100 can also include a coupling means 108 for coupling the unit to an implement. In an embodiment of the present invention, the coupling means 108 is configured to couple the chemical applicator 100 to a farm implement, such as a seed tender or grain cart, conveyor, or an auger for filling bins. The coupling means 108 can include a plurality of openings and at least one coupling member for each opening.

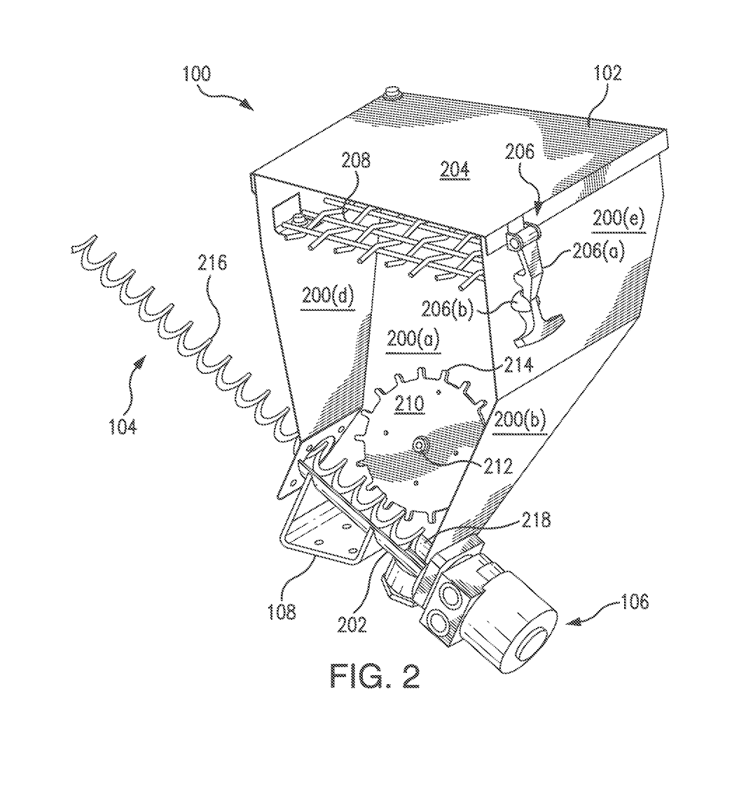

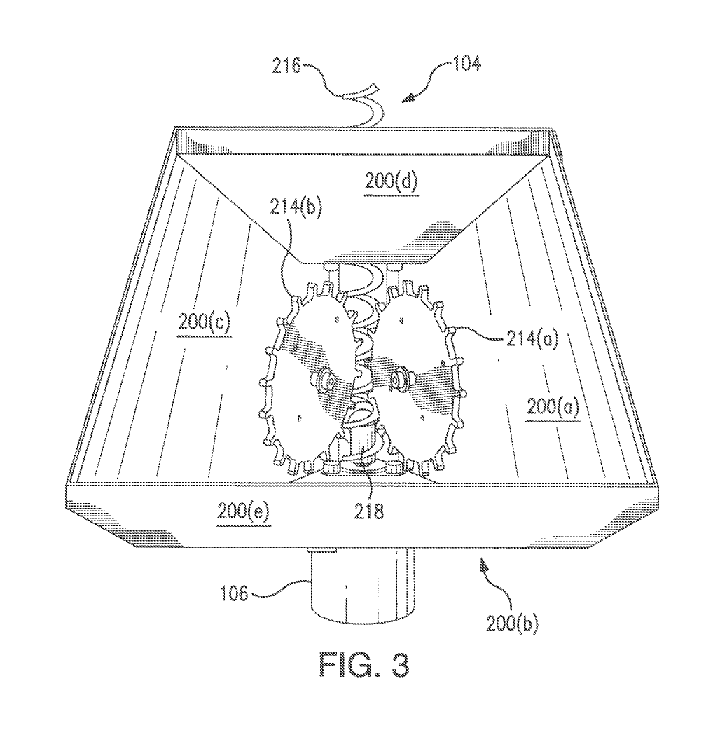

FIG. 2 illustrates a cutaway view of a chemical applicator 100 according to an embodiment of the present invention. The hopper 102 includes a plurality of downward sloping side walls 200(a)-(d) (200(c) can be seen in FIG. 3), a trough 202 at a bottom of the hopper, and a cover 204. The sloping side walls 200(a)-(d) converge at the bottom of the hopper 102 at trough 202. In an embodiment of the present invention, the hopper 102 can include sides with a plurality of walls at different angles. For example, a side of the hopper 102 can include walls 200(b) and 200(e), wherein wall 200(e) has a greater angle of inclination than wall 200(b). The cover 204 is positioned at the top of walls 200 of the hopper 102. The cover 204 is adjustable between an open and closed position. In the closed position, as illustrated in FIG. 2, the cover 204 covers the opening at the top of the hopper 102. In the open position, as illustrated in FIG. 3, the opening at the top of the hopper 102 is exposed and material can be loaded into the hopper 102. The hopper 102 can include a latch or locking member 206 for locking the cover 204 in a closed position. In an embodiment of the present invention, the locking mechanism 206 can include a latch handle 206(a) and a receiving member 206(b). The latch handle 206(a) can be removably coupled with the receiving member 206(b). The hopper 102 can further include a grate 208 for safety, e.g., to prevent users from putting their hands near the moving agitators or auger, and to sift material entering the hopper 102. In an embodiment of the present invention, the grate 208 can be positioned directly below the cover 204 when the cover 204 is in a closed position.

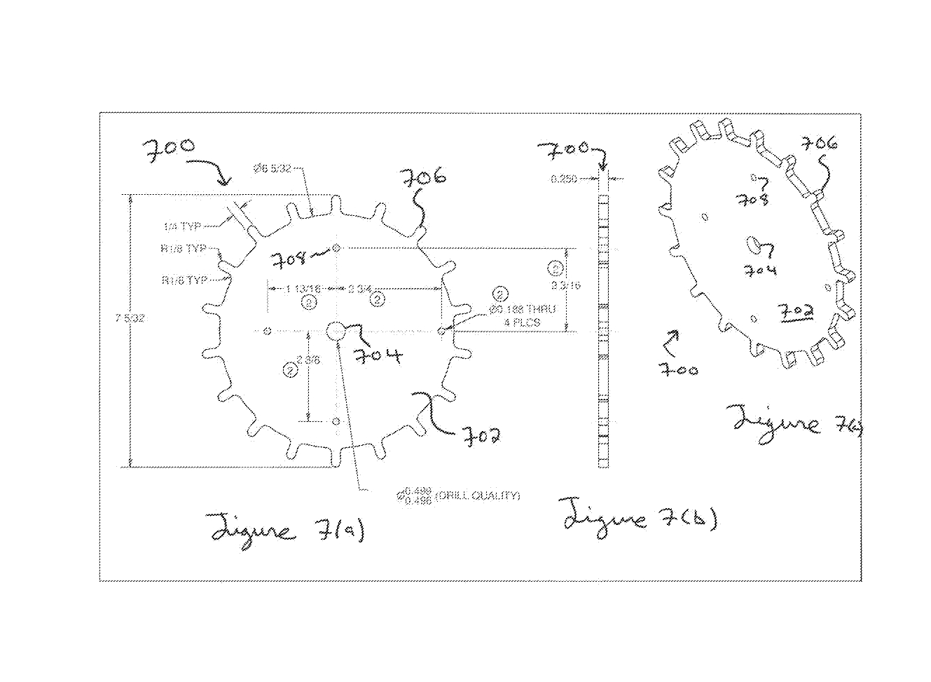

The chemical applicator further includes at least one agitator disc 210 configured to agitate the material in the hopper 102 such that packing is prevented. In an embodiment of the present invention, the agitator disc 210 is a circular disc. Each agitator disc 210 is rotatably coupled to a wall 200 of the hopper 102 by a coupling 212 (e.g., a bolt with spacers) such that the agitator disc 210 is capable of rotating freely about the coupling 212. Each agitator disc 210 further includes a plurality of teeth 214 spaced about an outer circumference of the disc, and each disc 210 is positioned such that a portion of at least one of the plurality of teeth 214 is positioned in the trough 202. The teeth 214 assist in agitating the material to prevent packing and also engage a conveying auger or flight 216 that extends axially along the trough and into the discharge spout 104, and which drives the agitator disc 210. In an embodiment of the present invention, the flight 216 is driven by a shaft 218 of the drive motor 106. As the flight 216 is driven by the shaft 218, the teeth 214 of the disc 210 are engaged by the helical coils of the flight 216, which causes the disc 210 to rotate. Preferred embodiments of the agitator disc and flight are discussed in further detail with respect to FIGS. 7(a)-(c) and 8(a)-(d).

FIG. 3 illustrates a top view of a chemical applicator according to an embodiment of the present invention. In the top view illustrated in FIG. 3, the cover 204 and the grate 208 are removed from the chemical applicator. In the embodiment shown in FIG. 3, the chemical agitator 100 includes two agitator discs 210(a) and 210(b). Each agitator disc 210(a) and (b) is rotatably coupled to a hopper wall 210 via a coupling 212(a) and (b). In an embodiment of the present invention, the agitator discs 210(a) and (b) are coupled to opposing hopper walls 200(a) and 200(c). In an embodiment of the present invention, each agitator disc 210 is approximately parallel to the hopper wall 200 to which it is coupled. In another embodiment of the present invention, each agitator disc 210 is at approximately the same angle from vertical, i.e., each agitator disc 210 is approximately 30 degrees from vertical. In an embodiment of the present invention, the agitator discs 210 are angled relative to each other such that their planes of inclination intersect at approximately the axis of rotation of the flight 216. In an embodiment of the present invention, each agitator disc 210 is approximately the same size. In another embodiment of the present invention, each agitator disc 210 is a different size. Having agitator discs 210 of different sizes is advantageous because each disc 210 will agitate different areas of the hopper 102, i.e., a small disc will agitate material near the bottom of the hopper 102 and a large disc will agitate material near the middle and top of the hopper 102.

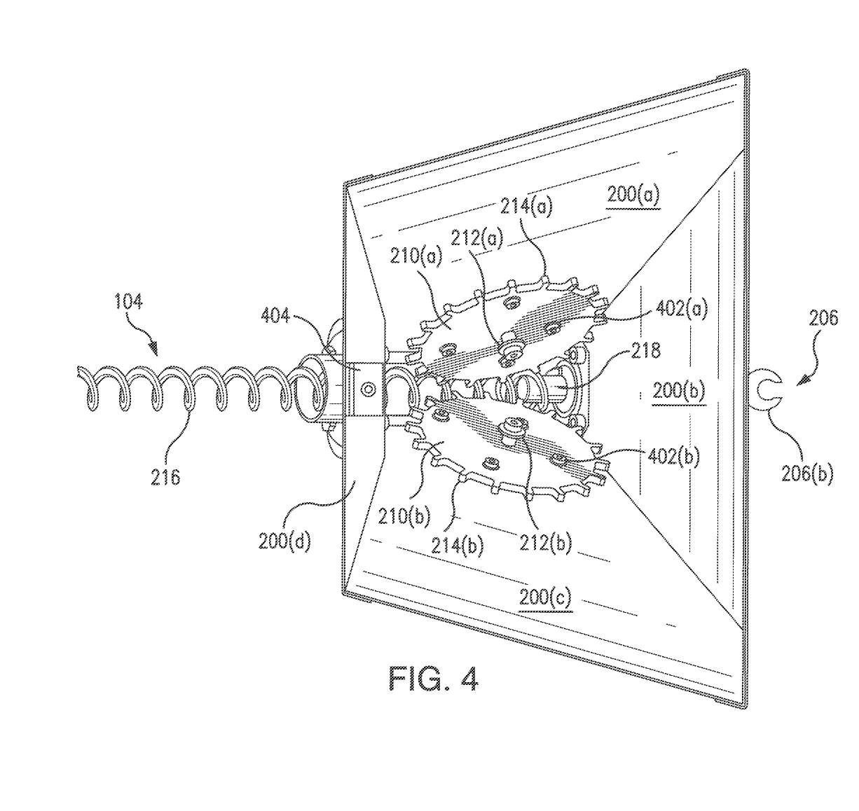

FIG. 4 is a top view of a chemical applicator according to another embodiment of the present invention. The agitator discs 210(a) and (b) include projections 402(a) and (b) from or through the body of the disc. The projections 402(a) and (b) can be approximately perpendicular to the teeth 214(a) and (b) of the discs 210(a) and (b). The projections 402(a) and (b) help to further agitate the chemicals. In an embodiment of the present invention, the projections 402(a) and (b) are removable from the disc body. The chemical applicator also includes a coupling 404 for the grate 208. The coupling 404 allows for the grate 208 to be removed from the chemical applicator. The grate 208 can be removed in order to access the agitator discs 210 and the other components housed within the hopper 102.

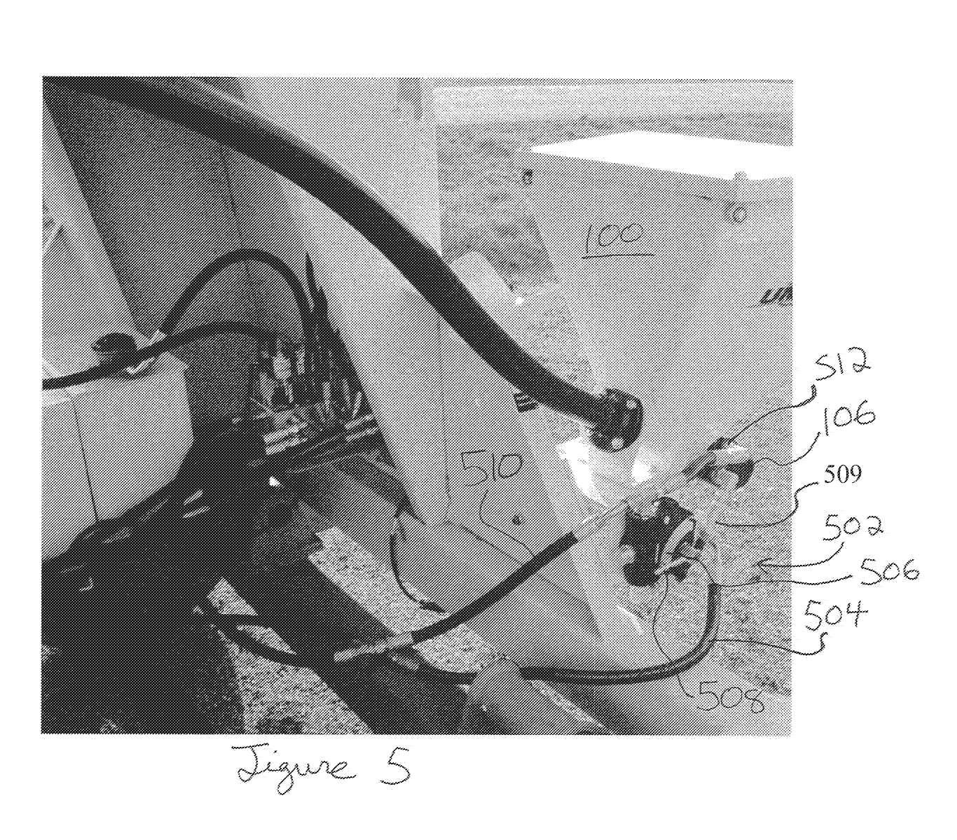

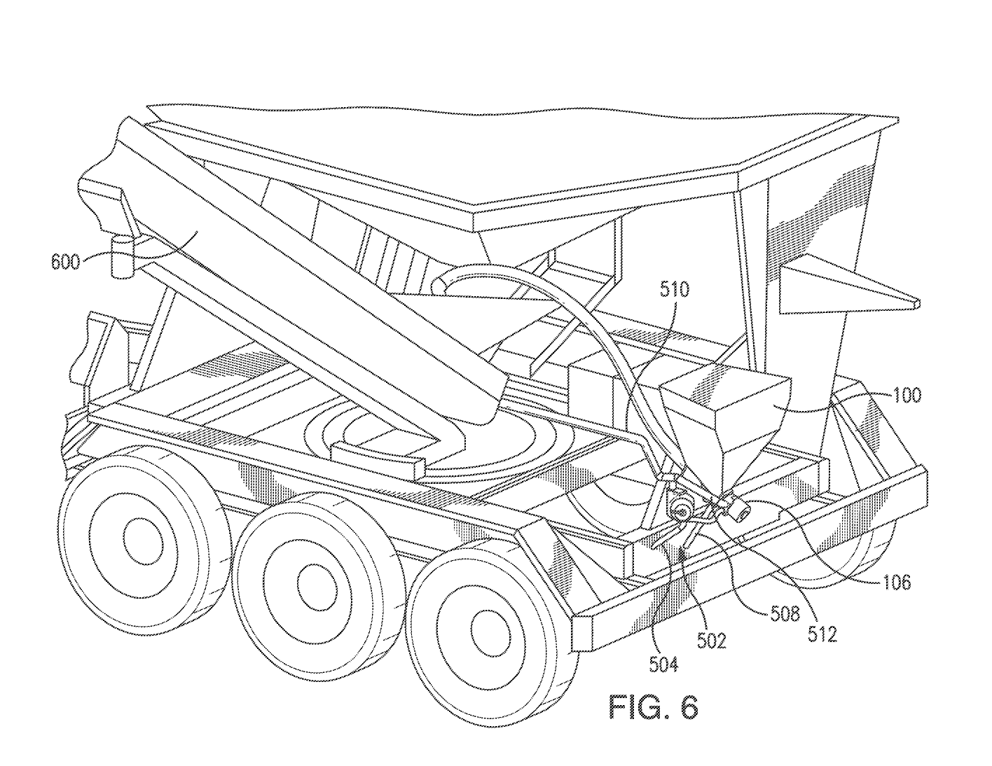

FIGS. 5 and 6 illustrate perspectives view of a chemical applicator according to another embodiment of the present invention. In this embodiment, the chemical applicator 100 is powered by the hydraulic system of a farm implement via a proportional rate device 502. Specifically, the proportional rate device 502 is coupled to the same hydraulic system that drives the conveying device of the farm implement. The proportional rate device 502 controls the speed of the chemical applicator 100, and thus the application rate of the chemicals. The proportional rate device 502 changes the speed of the chemical applicator 100 to keep it proportional to changes in the speed of a conveying device, such as a seed tender conveyor 600 as illustrated in FIG. 6. For example, if the conveying device 600 slows the rate at which it is conveying material, the proportional rate device 502 will slow the speed of the chemical applicator 100 such that the material being conveyed receives the same amount of chemical at all times (i.e., the same amount of chemical per unit volume).

In the embodiment shown, the proportional rate device 502 includes an input 504, a rate control 506 including a member for adjusting the rate 508, an output 509 to the applicator, and an output for excess hydraulic fluid 510. The input 504 receives hydraulic fluid from the same manifold as the conveying device 600. In an embodiment of the present invention, the chemical applicator and the conveying device 600 are hydraulically driven and the proportional rate device 502 is hydraulically driven in parallel with the conveying device 600. The input 504 provides hydraulic fluid to the rate control device 506. In an embodiment of the present invention, the rate control device 506 is a flow divider including a handle 508 which can be adjusted to control the amount of fluid driving the motor of the chemical applicator, and, thus, the rate of the chemical applicator 100 relative to the conveying device 600. In another embodiment of the present invention, the input 504 can receive information regarding the speed of the conveying device via speed sensors, circuit board or electronics, or by being mechanically coupled to the conveying device 600. The rate control 506 allows for an operator to adjust the rate of speed of the chemical applicator relative to the conveying device. This is primarily used to adjust the rate of the chemical applicator 100 for different materials with different flow rate and adhesive properties. For example, properties of a fertilizer may differ from the properties of talc and it may be useful to adjust the speed of the chemical applicator relative to the speed of the conveying device to compensate for these differences. The rate control 506 includes an output 509 to the motor of chemical applicator 100 and an output for excess fluid 510. The output to the chemical applicator 509 can be coupled to an input of the drive motor 106. The drive motor 106 can include an output for excess hydraulic fluid 512, which can feed into the output for excess fluid from the rate control 510. The output 510 deposits the excess hydraulic fluid in a reservoir so that it can be reused in the operation of the agricultural implement.

FIGS. 7(a)-(c) illustrate an agitator disc according to an embodiment of the present invention. The agitator disc 700 includes a body 702, a central opening 704, teeth 706 and a plurality of openings 708. In the embodiment shown, the agitator disc 700 is circular with an outer diameter of 7 and 5/32 inches, a body 702 having a diameter of approximately 6 and 5/32 inches, and teeth that are 0.5 inches high and 0.25 inches wide. The body 702 includes a central opening 704 configured to allow the agitator disc 700 to be rotatably coupled to a hopper wall. The central opening 704 can be approximately 0.496 to 0.499 inches. The teeth 706 protrude radially outwardly from the body 702. The plurality of teeth 706 can be approximately rectangular with rounded shoulders and tops. In alternative embodiments, the teeth 706 can be trapezoid, square, rectangular or have other configurations. In an embodiment of the present invention, the agitator disc 700 includes 18 teeth evenly spaced about the outer circumference of the body. The number of teeth can be varied to adjust the rate at which the agitator disc rotates relative to the auger or flight driving it. The agitator disc 700 can also include a plurality of openings 708 configured to receive protrusions, as illustrated in FIG. 4.

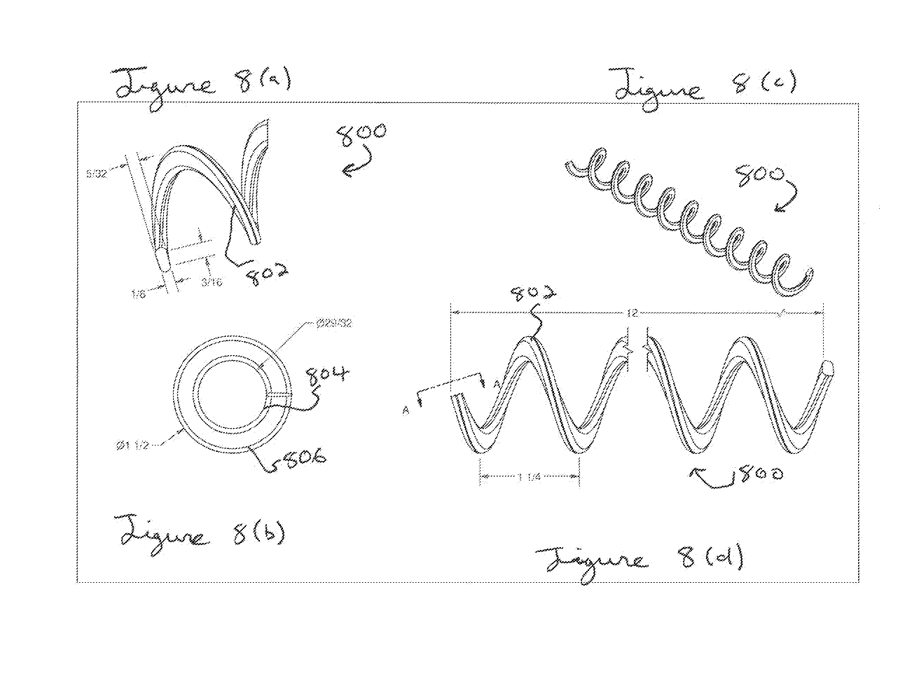

FIGS. 8(a)-(d) illustrate an auger or flight 800 according to an embodiment of the present invention. In the embodiment shown, the flight 800 is a wire with a plurality of helical coils 802. Each coil 802 includes an inner surface 804 and an outer surface 806. The flight 800 is composed of a wire approximately 3/16 inches high and 5/32 inches thick. The wire can have an approximately rectangular shape with curved ends. In another embodiment, the wire can have a different shape, such as circular or parallelogram. A single coil 802 can be approximately 1.25 inches long with an inner surface 804 diameter of approximately 29/32 inches and an outer surface 806 diameter of approximately 1.50 inches. In alternative embodiments, the flight can include helical blades, a screw-like member or the like.

From the above it will be appreciated that the chemical applicator of the present invention allows the material in the hopper to be agitated without the need for additional shafts, bearings or chains. It will also be appreciated that the chemical applicator can include a plurality of agitator discs driven by an auger. It will also be appreciated that various changes can be made to the system without departing from the spirit and scope of the appended claims. For example, further agitator discs can be positioned such that the agitator discs driven by the auger drive the additional discs, similar to a series of gears. Additionally, multiple agitator discs can be set up on the same coupling such that one agitator disc on the coupling is driven by the auger and the rotation of this disc drives all other discs on the coupling. In addition, while two agitator discs are shown, it will be appreciated that one or more than two discs can be positioned in the hopper to engage the flight. When more than one disc is positioned in the hopper, the discs can be parallel to one another or oriented at an angle relative to one another.

It will also be appreciated that the proportional rate drive applicator of the present invention allows for the rate at which chemicals are applied to the material being conveyed to be proportional relative to the speed at which material is conveyed. It will also be appreciated that various changes can be made to the system without departing from the spirit and scope of the appended claims. For example, the chemical applicator can be a stand-alone unit, i.e., not coupled to the agricultural machine or implement. The proportional rate device can be in communication with the conveying device via hydraulic lines or sensors such as speed sensors. Also, the unit can be controlled remotely, such that the rate control can be adjusted remotely and the entire unit can be turned on and off remotely, e.g., from the cab of a tractor towing a farm implement on which the chemical applicator is mounted.

We claim:

1. A chemical applicator for a farm implement with a conveyor, comprising:
a hopper including a trough and a discharge spout;
an auger rotatably moving in said discharge spout and said trough of the hopper, said auger having a longitudinal axis of rotation; and
at least one agitator disc rotatably mounted in the hopper, the at least one agitator disc including a main body and a plurality of teeth protruding outwardly from the main body,
wherein said at least one agitator disc is positioned in said hopper such that said auger engages one or more teeth of an agitator disc and causes the agitator disc to rotate when the auger rotates about said longitudinal axis of rotation.

2. The chemical applicator of claim 1, wherein first and second agitator discs are disposed in the hopper and said auger engages teeth on said first and second agitator discs.

3. The chemical applicator of claim 2, wherein the first and second agitator discs are disposed in planes, oriented at an angle relative to one another, that intersect along said longitudinal axis of rotation.

4. The chemical applicator of claim 2, wherein said first and second agitator discs are different sizes.

5. The chemical applicator of claim 1, wherein said at least one agitator disc is mounted in the hopper such that said teeth extend at least partially into said trough as the disc rotates.

6. The chemical applicator of claim 1, wherein said auger comprises flighting coupled to a drive motor.

7. The chemical applicator of claim 6, wherein said drive motor is coupled to a hydraulic system powering the farm implement conveyor, and the drive motor is configured to drive said flighting at a rate of speed proportional to a rate of speed of the conveyor.

8. A chemical applicator for a farm implement with a conveyor, comprising:
a hopper including a trough and a discharge spout;
an auger extending through said trough and said discharge spout;
a motor coupled with said auger to cause rotation thereof within said trough and said discharge spout; and
a proportional rate device configured to control a speed of said motor in proportion to a speed of the conveyor.

9. The chemical applicator of claim 8, wherein said proportional rate device includes a control to adjust the speed of said motor in proportion to the speed of the conveyor.

10. The chemical applicator of claim 8, wherein the farm implement includes a hydraulic system to drive the conveyor, and the proportional rate device is coupled to the hydraulic system.

11. The chemical applicator of claim 11, wherein the proportional rate device includes a control to adjust the amount of hydraulic fluid the proportional rate device receives relative to the conveyor.
